(19) United States
(12) Patent Application Publication
(10) Pub. No.: US 2010/0332247 A1
(43) Pub. Date: Dec. 30, 2010

(54) SYSTEMS AND METHODS FOR MANAGING AND DOCUMENTING HEALTHCARE EXPENSES PAID FROM A HEALTH SAVINGS ACCOUNT

(76) Inventor: Jamie Spriggs, Baltimore, MD (US)

Correspondence Address: BRYAN CAVE LLP, 211 NORTH BROADWAY, SUITE 3600, ST. LOUIS, MO, 63102-2750, US

(21) Appl. No.: 12/494,989

(22) Filed: Jun. 30, 2009

(51) Int. Cl. G06Q 50/00

(52) U.S. Cl. 705/2

(57) ABSTRACT

Systems and methods for facilitating the management and payment of healthcare expenses from a health savings account are provided. For example, the systems generally comprise a server which houses at least one database in which a plurality of member accounts are recorded. Each member account will preferably (i) list an amount of money deposited by a member into an HSA and (ii) store information that memorializes the payment of healthcare expenses paid by the member from the HSA. In addition, the server is preferably capable of receiving information from a website through which the member may access the member's account—and provide the server with the information that memorializes the payment of his or her healthcare expenses from the appropriate HSA.

### FIELD OF THE INVENTION

The field of the present invention relates to systems and methods for facilitating the management, payment, and documentation of healthcare expenses that are paid from a health savings account (HSA).

### BACKGROUND OF THE INVENTION

Health Savings Accounts (HSAs) represent a growing and effective alternative to traditional health insurance. More particularly, an HSA is a form of a savings product or financial account, which offers a different way for consumers to pay for their healthcare expenses. For example, certain qualified HSAs enable consumers to divert and save portions of their income on a tax-preferred basis to pay for current healthcare expenses, while simultaneously saving for future qualified medical and retiree health expenses on a tax-free basis. Indeed, HSAs enable consumers to deposit money on a tax-preferred basis, which money may later be used to fund healthcare expenses.

The expenses paid from HSAs, however, must be documented and preferably evidenced by archiving the applicable medical invoices, receipts, and other records. That is, the medical invoices, receipts and other evidence of payment of such expenses must be kept by consumers, in order to comply with various tax laws that govern the use of such HSAs. Accordingly, a growing need and demand exists for centralized and easy-to-use systems and methods that will allow consumers to quickly and securely archive such receipts and other evidence of payment of healthcare expenses from an HSA, as well as facilitate the management and operation of such HSAs.

As the following will demonstrate, the present invention addresses such needs and demands in the marketplace.

### SUMMARY OF THE INVENTION

According to certain aspects of the invention, systems to facilitate the management and payment of healthcare expenses from a health savings account are provided. According to such embodiments, the systems generally comprises a server which houses at least one database in which a plurality of member accounts are recorded. The invention provides that each member account will preferably (i) list an amount of money deposited by a member into an HSA (and the amount of money accrued, if any, from investing such deposited funds) and (ii) store information that memorializes the payment of healthcare expenses paid by the member from the HSA. In addition, the invention provides that the server is preferably capable of receiving information from a website through which the member may access the member's account—and provide the server with the information that memorializes the payment of his or her healthcare expenses from the appropriate HSA.

According to additional related aspects of the invention, methods for facilitating the management and payment of healthcare expenses from a health savings account are provided. The methods generally comprise providing a server which houses a database. The invention provides that a plurality of member accounts are preferably recorded within the database, with each member account listing an amount of money deposited by a member into an HSA. In addition, each member account will preferably allow the appropriate member to store information that memorializes the payment of a healthcare expense paid by the member from his or her HSA, such as by allowing the member to upload images of the applicable medical invoices and receipts to the server. Still further, the methods of the present invention further include providing a website through which the member may (i) access the member's account stored within or accessible by the server and (ii) provide the server with the information that memorializes the payment of the healthcare expense from his or her HSA.

The above-mentioned and additional aspects of the present invention are further illustrated in the Detailed Description of the Invention below.

### BRIEF DESCRIPTION OF THE FIGURES

FIG. 1 is a schematic which illustrates the various components of the systems described herein.

FIG. 2 is an illustration of a non-limiting example of an on-line form through which a dedicated username and password may be submitted to a server, to gain access to a member's HSA management account.

FIG. 3 is an illustration of a non-limiting example of an on-line form which a member may use to establish the member's HSA management account and record the same within the database described herein.

FIG. 4 is a schematic which illustrates the function and role of the system administrator and centralized website described herein.

FIG. 5 is a flow diagram which illustrates the various steps of the methods described herein.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used, and made without departing from the scope and spirit of the invention.

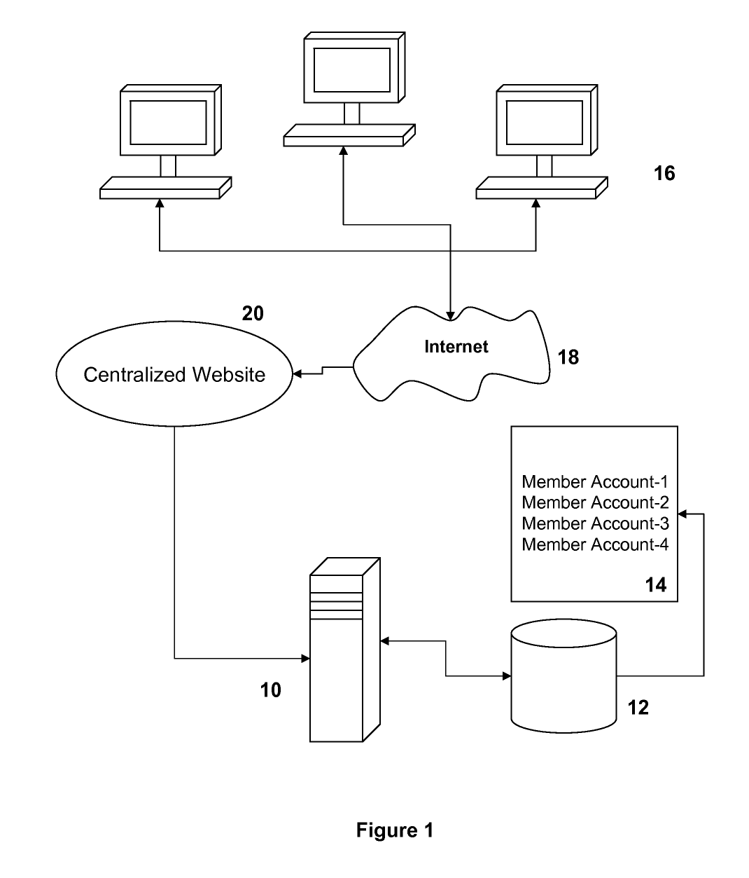

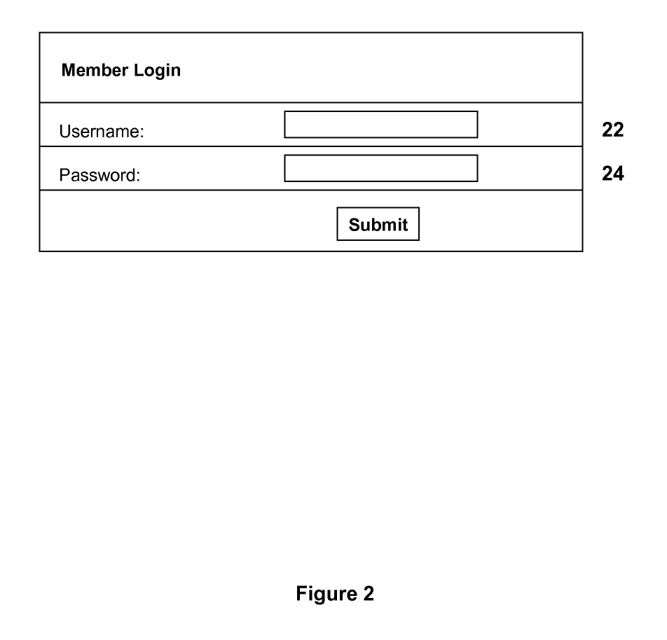

Referring now to FIG. 1, according to certain preferred embodiments of the invention, systems to facilitate the management and payment of healthcare expenses from a health savings account (HSA) are provided. According to such embodiments, the systems generally comprise a server 10 which houses at least one database 12 in which a plurality of member accounts 14 are recorded. The invention provides that each member account 14 will preferably list, and make available to each member, various types of information regarding his or her HSA. For example, each member account 14 may display, through a secure and password-protected on-line environment, an amount of money deposited by a member into an HSA. In addition, the database will store information, which is correlated with the member's account 14 and may be viewed within the on-line environment, which memorializes the payment of healthcare expense paid by the member from the HSA. The member accounts 14 may be accessed vis-a-vis any computer terminal 16 having an internet connection 18. Referring to FIG. 2, a member will preferably access his or her personalized member account 14 through the computer terminal 16 by submitting to the server 10, a username 22 and/or password 24 that is dedicated to such member and recorded within the database 12. In the event that the username 22 and/or password 24 that is submitted by the member matches the username 22 and/or password 24 recorded within the database 12 for such member, the system will grant the member access to his or her personalized member account 14 through the computer terminal 16.

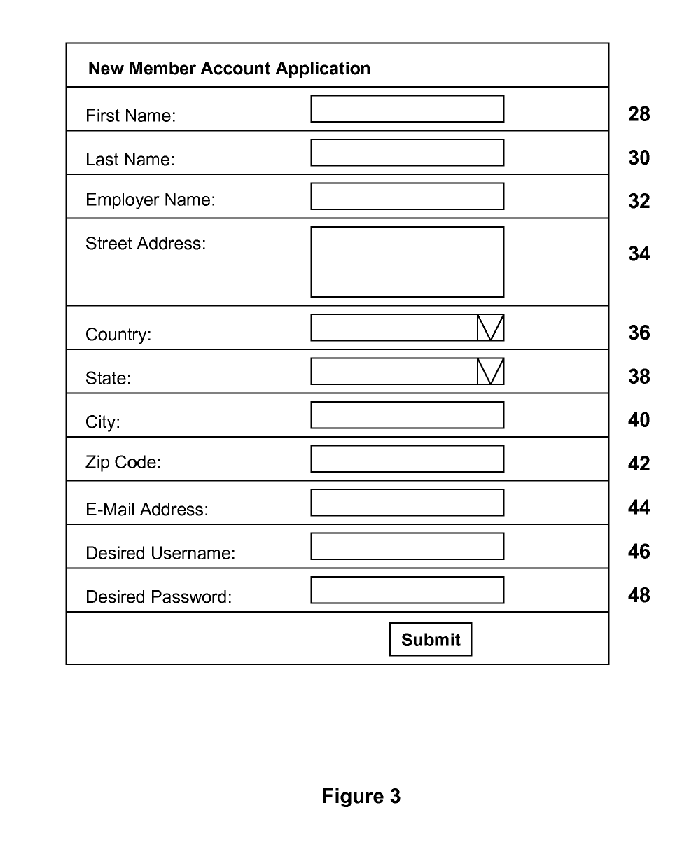

The invention provides that, according to certain preferred embodiments, a member may establish a member account 14 by submitting certain identifying information to the server 10 through a computer terminal 16, which will then be recorded in the database 12. For example, such information may be submitted to the server 10 using an on-line form, which may be accessible within a centralized website 20 (FIG. 1). As illustrated in FIG. 3, for example, the on-line form may require the member to submit to the sever 10 his or her first name 28, last name 30, employer name 32, street address 34, country 36, state 38, city 40, zip code 42, e-mail address 44, desired username 46, and desired password 48. Upon submitting such information to the server 10, the systems described herein may create a member account 14 for such member, based on the information submitted, which will be recorded within and accessible from the database 12.

The invention provides that the information that memorializes the payment of healthcare expenses may be, for example, an image of a receipt, medical invoice, a medical claim, or combinations thereof. According to certain preferred embodiments, as explained above, the invention provides that the server 10 is preferably capable of receiving information from a centralized website 20 through which the member may access the member's account 14. The centralized website 20 may preferably further be used to provide the server with the information that memorializes the payment of a member's healthcare expenses from the appropriate HSA. For example, the invention provides that a member may provide the server 10 with the information that memorializes the payment of a healthcare expense by uploading, for example, an image of a receipt, medical invoice, or a medical claim to the server 10 through the website 20. Alternatively, the invention provides that a member may provide the server 10 with the information that memorializes the payment of a healthcare expense by faxing a receipt, medical invoice, or a medical claim, along with a cover sheet, to a dedicated fax line. According to such embodiments, the cover sheet will preferably comprise a bar code that is correlated within the database 12 with the applicable member. Upon being faxed to the dedicated fax line, the (1) receipt, medical invoice, and/or medical claim and (2) cover sheet are converted into an image; the bar code is scanned and a numeric identifier is derived from the scan; the database 12 is queried to identify the member account 14 that is correlated with the numeric identifier; and the image is saved to and recorded within the database 12 in association with the appropriate member account 14 (which is correlated with the same numeric identifier as that which is derived from scanning the bar code affixed to the fax cover sheet described above).

The invention provides that the database 12 in which the plurality of member accounts 14 are recorded may exist within the same, or different, servers. For example, the database 12 in which the plurality of member accounts 14 are recorded may exist within a first server, whereas as the website through which a member may submit such information to the first server may be hosted on a second server, provided that the first server and second server may communicate with each other.

Still further, the invention provides that each member's account 14 preferably lists and allows each member to retrieve all healthcare expenses paid by each member within a defined period of time, such as within a calendar year. This way, all healthcare expenses paid from the HSA may be reconciled, if necessary, when reporting taxes during any given year. In addition, the systems described herein may allow each member to generate reports, which summarize the healthcare expenses paid by a member within a defined period of time.

According to certain embodiments of the present invention, the member's account 14 may further allow a member to make deposits of additional funds from a bank account into the member's account 14. Such deposits may be consummated electronically, e.g., vis-à-vis bank wire transfers, payroll deduction, and/or by providing the HSA administrator with a conventional check. Preferably, the deposits will be consummated vis-à-vis regularly-scheduled payroll deductions. However, the invention is not limited in this regard, and a member may submit deposits of money through any other acceptable means. Still further, according to certain embodiments of the invention, a member's account 14 will allow the member to, optionally, invest the amount of money deposited by the member in one or more investments.

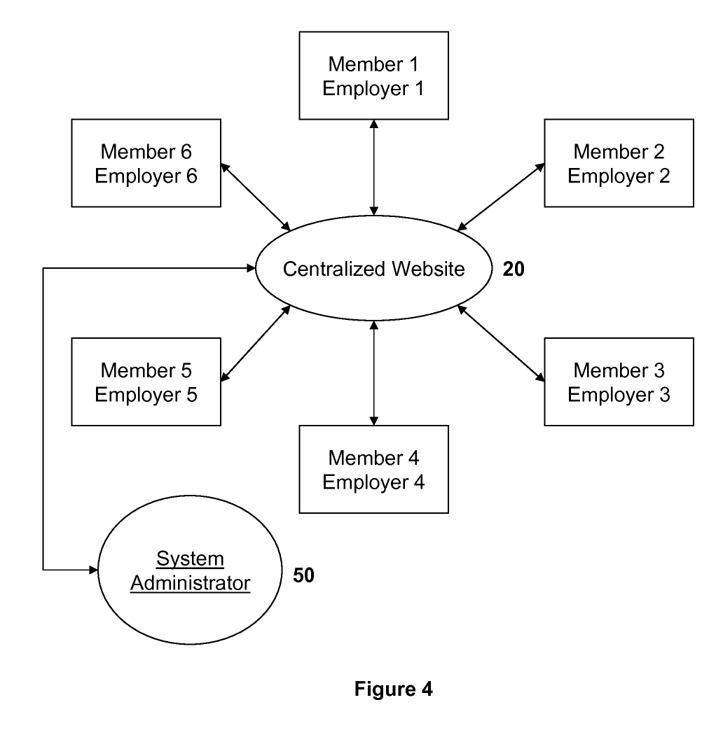

The invention provides that the systems described herein may be managed and controlled by a system administrator. According to such embodiments, the invention provides that the system administrator may be enabled to deduct fees from the member's account or, more particularly, from the funds deposited within such member's HSA (which is accessed and managed by the member using the systems described herein). Such fees may be charged, for example, in consideration for the administrator's provision, operation, and maintenance of the system described herein. For example, the fees may be charged and collected in the form of (i) regular cash deductions from the member's account (HSA), (ii) transactional fees charged for investment transactions consummated by the member within or using the member's account, or (iii) combinations of the foregoing. Referring to FIG. 4, the invention provides that the centralized website 20 described herein may be operated by the system administrator 50. According to such embodiments, a plurality of members (who may be employed by a plurality of different employers) may be allowed to manage and document the payment of healthcare expenses—that are paid from a health savings account (HSA)—using the centralized and standardized platform provided by the system administrator 50 through the centralized website 20 described herein.

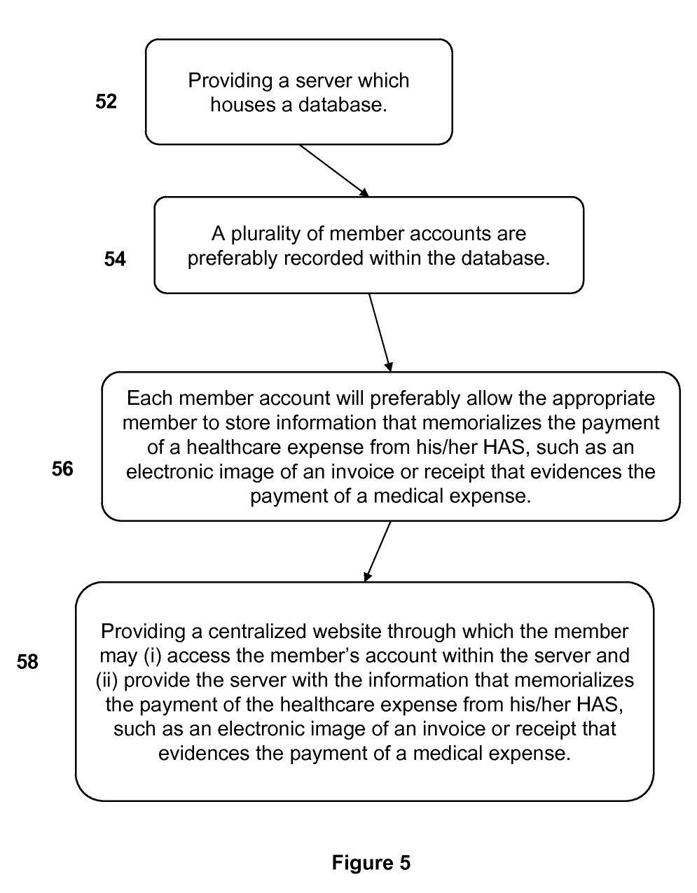

Referring now to FIG. 5, according to additional related aspects of the invention, methods for facilitating the management and payment of healthcare expenses from a health savings account are provided. The methods generally comprise providing a server which houses a database 52. The invention provides that a plurality of member accounts are preferably recorded within the database 54, with each member account listing an amount of money deposited by a member for an HSA. In addition, each member account will preferably allow the appropriate member to store information that memorializes the payment of a healthcare expense paid by the member from his or her HSA 56. Still further, the methods of the present invention further include providing a centralized website 58 through which the member may (i) access the member's account within the server and (ii) provide the server with the information that memorializes the payment of the healthcare expense from his or her HSA.

Although illustrative embodiments of the present invention have been described herein, it should be understood that the invention is not limited to those described, and that various other changes or modifications may be made by one skilled in the art without departing from the scope or spirit of the invention.

What is claimed is:

1. A system to facilitate the management and payment of healthcare expenses from a health savings account, which comprises a server which:
(a) comprises a database in which a plurality of member accounts are recorded, wherein each member account (i) lists an amount of money deposited by a member and (ii) stores information that memorializes a payment of a healthcare expense paid by the member; and
(b) is capable of receiving information from a website through which the member may (i) access the member's account and (ii) provide the server with the information that memorializes the payment of the healthcare expense.

2. The system of claim 1, wherein the information that memorializes the payment of the healthcare expense is an image of a receipt, medical invoice, a medical claim, or combinations thereof.

3. The system of claim 1, wherein the member's account lists and allows the member to retrieve all healthcare expenses paid by the member with a defined period of time.

4. The system of claim 1, wherein the member's account allows the member to make deposits of additional funds from a bank account into the member's account.

5. The system of claim 1, wherein the member's account allows the member to invest the amount of money deposited by the member in one or more investments.

6. The system of claim 1, wherein the member provides the server with the information that memorializes the payment of the healthcare expense by uploading an image of a receipt, medical invoice, or a medical claim to the server through the website.

7. The system of claim 1, wherein the member provides the server with the information that memorializes the payment of the healthcare expense by faxing a receipt, medical invoice, or a medical claim, along with a cover sheet, to a dedicated fax line, wherein the cover sheet comprises a bar code that is correlated within the database with the member.

8. The system of claim 1, which further allows a system administrator to deduct fees from the member's account.

9. The system of claim 8, wherein the fees are (i) regular cash deductions from the member's account, (ii) transactional fees charged for investment transactions consummated by the member, or (iii) combinations of the foregoing.

10. The system of claim 9, wherein the database in which the plurality of member accounts are recorded exists in a first server, whereas the website is hosted on a second server.

11. A method for facilitating the management and payment of healthcare expenses from a health savings account, which comprises the steps of:
(a) providing a server which houses a database in which a plurality of member accounts are recorded, wherein each member account (i) lists an amount of money deposited by a member and (ii) stores information that memorializes a payment of a healthcare expense paid by the member; and
(b) providing a website through which the member may (i) access the member's account within the server and (ii) provide the server with the information that memorializes the payment of the healthcare expense.

12. The method of claim 11, wherein the information that memorializes the payment of the healthcare expense is an image of a receipt, medical invoice, a medical claim, or combinations thereof.

13. The method of claim 11, wherein the member's account lists and allows the member to retrieve all healthcare expenses paid by the member with a defined period of time.

14. The method of claim 11, wherein the member's account allows the member to make deposits of additional funds from a bank account into the member's account.

15. The method of claim 11, wherein the member's account allows the member to invest the amount of money deposited by the member in one or more investments.

16. The method of claim 11, which further comprises the member providing the server with the information that memorializes the payment of the healthcare expense by uploading an image of a receipt, medical invoice, or a medical claim to the server through the website.

17. The method of claim 11, wherein the member provides the server with the information that memorializes the payment of the healthcare expense by faxing a receipt, medical invoice, or a medical claim, along with a cover sheet, to a dedicated fax line, wherein the cover sheet comprises a bar code that is correlated within the database with the member.

18. The method of claim 11, which further comprises a system administrator deducting fees from the member's account.

19. The method of claim 18, wherein the fees are (i) regular cash deductions from the member's account, (ii) transactional fees charged for investment transactions consummated by the member, or (iii) combinations of the foregoing.

20. The method of claim 19, wherein the database in which the plurality of member accounts are recorded exists in a first server, whereas the website is hosted on a second server.
